(19) United States
(12) Patent Application Publication
(10) Pub. No.: US 2018/0193816 A1
(43) Pub. Date: Jul. 12, 2018

(54) DESIGNS OF EXOTHERMIC REACTORS

(71) Applicant: Industrial Heat, LLC, Raleigh, NC (US)

(72) Inventor: Dennis G. Letts, Austin, TX (US)

(21) Appl. No.: 15/683,208

(22) Filed: Aug. 22, 2017

Related U.S. Application Data
(60) Provisional application No. 62/378,363, filed on Aug. 23, 2016.

(51) Int. Cl. B01J 19/18; G21C 3/62

(52) U.S. Cl. CPC B01J 19/18; G21C 3/623

(57) ABSTRACT

An exothermic reaction chamber includes at least one of an annular sleeve hosting a hydrogen-absorbing metal, and an electrode having either an outer diameter greater than 50 percent of the reaction chamber bore diameter, perturbations formed on the electrode outer surface, or both. The anode-to-cathode distance may be varied by controlling either or both of the thickness of the annular sleeve and the electrode diameter. Perturbations on the electrode outer surface, which facilitate electrical discharge, may be formed by winding wire around the electrode in a helical pattern, by machining the electrode, or by drilling holes through the electrode and inserting metal rods having pointed or rounded tips into the holes. Both by reducing the anode-to-cathode distance and via perturbations on the outer surface of the electrode, electrical discharge is enhanced. Electrical discharge may drive more hydrogen (deuterium) ions into the hydrogen-absorbing metal, enhancing the efficiency of exothermic reactions.

### CROSS-REFERENCE TO RELATED APPLICATIONS

This application claims priority to U.S. Provisional Patent Application No. 62/378,363 filed on Aug. 23, 2016, the entire contents of which are incorporated by reference herein.

### FIELD OF INVENTION

The present invention relates generally to exothermic reactions, and in particular to designs of reactors hosting exothermic reactions.

### BACKGROUND

An ongoing field of energy research relates to exothermic reactions—in which a controlled reaction produces more heat than can be accounted for by the energy input and/or chemical reactions. In particular, one field of this research employs a dry electrolysis type apparatus to load hydrogen or deuterium ions into the metal lattice structure of a hydrogen-absorbing metal, which triggers an exothermic reaction.

FIG. 1 is a section view of a plasma type of exothermic reaction chamber 100. The reaction chamber 100 comprises a cylinder 102 formed of a rugged metal, e.g., stainless steel. For example, the cylinder 102 may be approximately a foot long and an inch in diameter. The cylinder 102, which has one open end, is fitted with a lid 106 and hermetically sealed, allowing the interior to be drawn to a vacuum of 10⁻⁶-10⁻⁷ Tor. The interior wall of the cylinder 102 may be plated with a shielding metal 108, such as gold (Au), and then with hydrogen-absorbing metal 110, such as palladium (Pd) or Nickel (Ni). Hydrogen (H) has an affinity for the metal lattice of the hydrogen-absorbing metal 110, and an aversion to that of the shielding metal 108. Hence, the shielding metal 108 may act as a seal to maintain hydrogen nuclei in the hydrogen-absorbing metal 110.

The metal cylinder 102 is grounded, forming an effective cathode, and an electrode 104, acting as an anode, is positioned in the center. Hydrogen or deuterium (²H, a stable isotope of H, also known as “heavy H”) is introduced into the cylinder 102 at a low pressure via passage 114 through the lid 106. High-voltage, low-current power is applied to the electrode 104 via a power supply coupling 116. The high voltage along the electrode 104 generates an electric field directed radially outwardly, which ionizes the hydrogen or deuterium and accelerates it toward and into the hydrogen-absorbing metal 110. An insulating collar 118, formed for example of Teflon®, covers the electrode 104 over the area opposite the cylinder 102 that is not plated with shielding metal 108 or hydrogen-absorbing metal 110, to prevent electrical discharge directly from the electrode 104 to the grounded cylinder 102.

The number of hydrogen (deuterium) ions that are accelerated toward the cathode depends on the current that flows between the anode and the cathode. This number can be quantified simply as D=6.24E18*I, where D has the units of deuterons per second and the current I is in amperes. The current I determines how many hydrogen (deuterium) ions move per second, while the voltage applied to the electrode 104 determines how fast they move.

In a typical exothermic reaction chamber 100, such as that depicted in FIG. 1, the electrode 104 is a slender rod, e.g., on the order of 1/16 inch in diameter. The rod is positioned along the center axis of the cylinder 102, and is a fixed distance from the hydrogen-absorbing metal 110 (which is electrically connected to the cylinder 102 and hence serves as the cathode).

The loading of hydrogen (deuterium) ions into the hydrogen-absorbing metal 110 is believed to depend on several factors, including voltage applied to the anode 104, the internal pressure of the reaction chamber 100, and the anode-to-cathode distance. The voltage and pressure are easily controlled; however, the size and shape of the electrode 104 used for an anode typically does not change, yet it may contribute to triggering an exothermic reaction. Additionally, the shape and texture of the surface of the electrode 104 may influence the rate of electrical discharge from the electrode 104 to the cathode 110.

The hydrogen-absorbing metal 110 (and shielding metal 108) is typically plated onto the interior surface of the cylinder 102. Alternatively, the electrode 104 may be plated, and a voltage applied to the cylinder 102, effectively reversing the anode/cathode configuration. In this alternative, particularly with slender electrodes 104, insufficient hydrogen-absorbing metal is deposited onto the electrode 104 to trigger robust exothermic reactions. Additionally, the electrode 104 has no direct thermal coupling to the exothermic reaction chamber 100, making it difficult to monitor any exothermic reaction. Accordingly, plating the hydrogen-absorbing metal 110 (and shielding metal 108) onto the interior surface of the cylinder 102 is the superior option.

However, this configuration presents deficiencies. Following one or several exothermic reaction experiments, the hydrogen-absorbing metal layer 110 must be scraped from the interior surface of the cylinder, e.g., with a wire brush. The deposits removed are then collected and analyzed in a lab, e.g., using species analysis to determine the nature of the reactions. The amount of material plated and subsequently removed from the inner wall is typically 0.1 g. This small mass limits the ultimate power output, and it is difficult to recover all of the material when it is scraped from the cylinder 102. Additionally, plated deposits are not as robust as solid metals, and plating the interior surface of a closed cylinder 102 limits the visibility of the plated surface.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments of the present invention, an exothermic reaction chamber includes at least one of an annular sleeve hosting a hydrogen-absorbing metal; and an electrode having either an outer diameter greater than 50 percent of the reaction chamber bore diameter, perturbations formed on the electrode outer surface, or both. The anode-to-cathode distance may be varied by controlling either or both of the thickness of the annular sleeve and the electrode diameter. Perturbations on the electrode outer surface, which facilitates electrical discharge, may be formed by winding wire around the electrode in a helical pattern, by machining the electrode, or by drilling holes through the electrode and inserting metal rods having pointed or rounded tips into the holes. By both reducing the anode-to-cathode distance, and via perturbations on the outer surface of the electrode, electrical discharge is enhanced, which may drive more hydrogen (deuterium) ions into the hydrogen-absorbing metal, enhancing the efficiency of exothermic reactions.

One embodiment relates to an exothermic reaction chamber. The reaction chamber includes a cylindrical metal housing having an inner diameter and at least one open end. It also includes an annular sleeve having a longitudinal bore. The outer diameter of the sleeve is substantially equal to the metal housing inner diameter. The sleeve is operative to be removeably disposed within the metal housing. The sleeve comprises a hydrogen-absorbing metal on at least the surface of the bore. The exothermic reaction chamber further includes a generally cylindrical electrode having an outer diameter less than an inner diameter of the annular sleeve. The outer surface of the electrode has a plurality of perturbations thereon, which are operative to stimulate electrical discharge between the electrode and the inner surface of the annular sleeve.

Another embodiment relates to an annular sleeve for an exothermic reaction chamber comprising a cylindrical metal housing having an inner diameter and at least one open end. The annular sleeve is formed of metal and has a longitudinal bore. The outer diameter of the annular sleeve is substantially equal to an inner diameter of the metal housing. The annular sleeve is operative to be removeably disposed within the metal housing. The annular sleeve comprises a hydrogen-absorbing metal on at least the bore surface.

Yet another embodiment relates to an electrode for an exothermic reaction chamber comprising a cylindrical metal housing having at least one open end and having a hydrogen-absorbing metal on the surface of an interior bore having a diameter. The generally cylindrical metal electrode has an outer diameter between 50% and 100% of the bore diameter, and further has a connection pin operative to connect the electrode to a power supply.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a section view of a prior art exothermic reaction chamber.

FIG. 2 is a perspective view of an annular sleeve for an exothermic reaction chamber.

FIG. 3A is a section diagram of a prior art electrode.

FIG. 3B is a section diagram of an electrode having a larger outer diameter.

FIG. 3C is a section diagram of an electrode having perturbations formed by rods.

FIG. 3D is an embodiment of the illustration of FIG. 3C.

FIG. 4 is a section view of representative shapes for protrusions on the surface of an electrode.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well-known methods and structures have not been described in detail so as not to unnecessarily obscure the present invention.

### Annular Sleeve

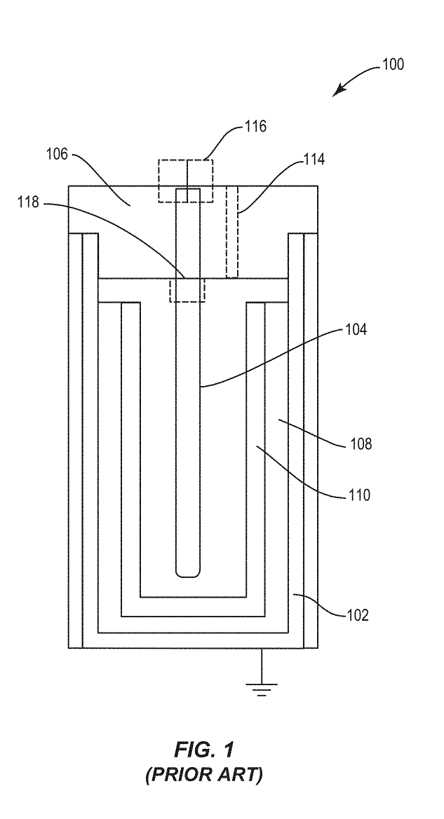

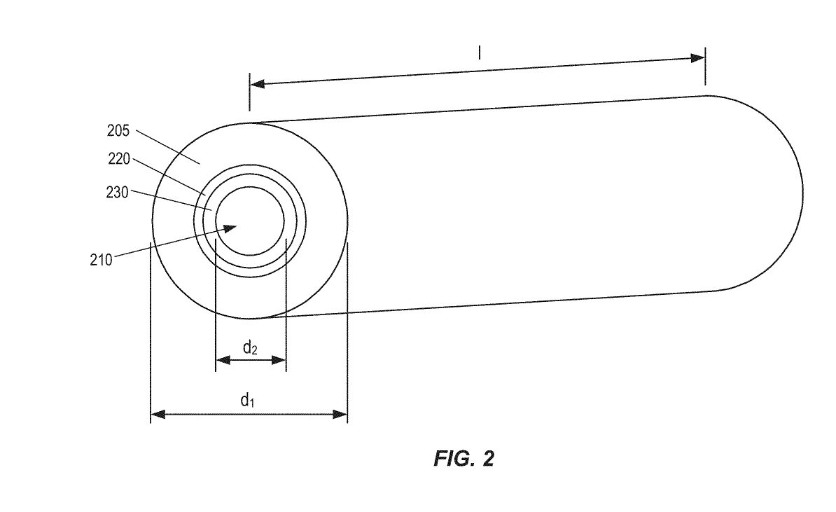

FIG. 2 depicts an annular sleeve 200 for use in an exothermic reaction chamber similar to that depicted in FIG. 1 (but without the shielding metal 108 and hydrogen-absorbing metal 110 layers plated onto the cylinder 102). The annular sleeve 200 comprises a body 205 which is machined out of a non-precious metal with good thermal conductivity. This could be 316L stainless steel because of its hydrogen containment advantages and because it would match the thermal expansion properties of the reaction chamber cylinder into which it is inserted.

The annular sleeve body 205 is machined to have an outer diameter d₁ substantially equal to the inner diameter of the reaction chamber cylinder. This provides a friction fit into the reaction chamber cylinder, placing the annular sleeve 200 and reaction chamber cylinder in good thermal transfer relationship. In one embodiment, a thermal coating is used to aid in thermal transfer, and also provide a lubricant assisting extraction of the sleeve 200.

The length l of the annular sleeve 200 may be varied as required or desired. Factors to consider in determining the length l of an annular sleeve 200 for any given exothermic reaction chamber or experiment include the length of the reaction chamber, and the volume of hydrogen-absorbing metal required. Reactor power is conjectured to be directly proportional to hydrogen-absorbing metal volume. In one embodiment, the length l of the annular sleeve 200 ranges from one to six inches.

A longitudinal bore 210 is formed in the center of the annular sleeve body 205, which runs throughout its length l. In one embodiment, the surface of the bore 210 may be plated with a layer of shielding metal 220, such as gold. The gold layer 220 may then be plated with a layer of hydrogen-absorbing metal 230, such as palladium or nickel. In one embodiment, the shielding metal layer 220 is omitted, and the hydrogen-absorbing metal layer 230 is plated directly onto the annular sleeve body 210. The size of the bore 210 drilled, as well as the thicknesses of the shielding metal layer 220 and hydrogen-absorbing metal layer 230 (as well as any other layers), determine the bore diameter d₂. The bore diameter d₂, along with the size of an electrode (as disclosed further herein), determines the anode-to-cathode spacing, which may be varied to optimize the electrical discharge, and hence the loading of hydrogen or deuterium ions into the hydrogen-absorbing metal layer 230.

The shielding metal layer 220 and hydrogen-absorbing metal layer 230—and such other layers as may be required or desired—may be deposited using any known metallurgical technique to provide the desired solid state or crystalline properties. Nano surfaces or layered surfaces may be created. In general, complete control over the metallurgical aspects of the annular sleeve 200 allows for experimentation and optimization of the physical properties of an exothermic reaction chamber.

In use, once prepared, the annular sleeve 200 is inserted into an exothermic reaction chamber. It may be press-fit into the reaction chamber for good thermal conductivity. After an experimental or production exothermic reaction, the annular sleeve 200 may be retracted and analyzed. In one embodiment, one or more holes may be formed in the bore 210 to accept corresponding prongs of an extraction tool. In other embodiments, a hook or similar extraction assistance means may be formed in or attached to the annular sleeve body 205. The entire annular sleeve 200 may be transferred to a laboratory for complete analysis, without the need to extract the hydrogen-absorbing metal from the inner surface of the reaction chamber (and concomitant problem of retrieving all of the metal shavings). A new annular sleeve 200 may then be inserted into the exothermic reaction chamber, which may immediately resume operation, with minimal downtime.

Annular sleeves 200 for exothermic reaction chambers according to embodiments of the present invention present numerous advantages over reaction chambers of the prior art. The annular sleeve 200 may be prepared using plating or any other metallurgical process. The size and volume of the annular sleeve 200 is controllable. Exothermic reactor power is proportional to the volume of hydrogen-absorbing metal. The annular sleeve 200 can be made more robust than prior art plated deposits. The cylindrical annular sleeve 200 can be press-fit into the exothermic reaction chamber and maintain good thermal contact with the cylinder, where heat is most useful. The annular sleeve 200 can be removed using an extractor tool. Once removed, the annular sleeve 200 can be easily transferred to an analytical lab for testing. Also, the annular sleeve 200 allows the operator to recover all of the active material for testing.

### Electrode Size and Shape

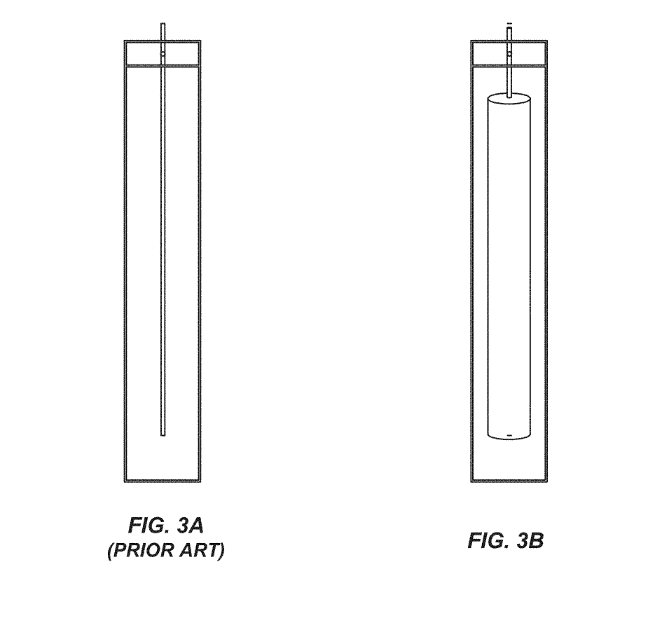

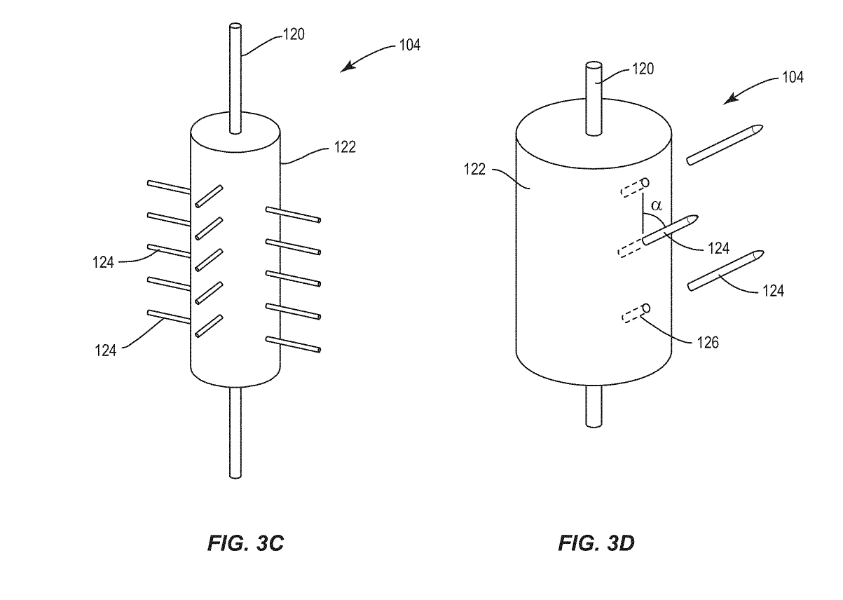

The anode-to-cathode distance may also be controlled by altering the outer diameter of the anode electrode. FIG. 3A depicts a typical prior art electrode in an exothermic reaction chamber. In this example, the inner diameter of the housing (grounded to form a cathode) is ⅞ inches. The anode outer diameter is 1/16 inches. The relatively large distance between the outer surface of the electrode and the inner wall of the reaction chamber cylinder (more accurately, the hydrogen-absorbing layer plated thereon, although the thickness of plated metal layers is negligible for the purpose of this discussion) requires very high voltage to initiate an electrical discharge between the anode and cathode.

In one embodiment of the present invention, as depicted in FIG. 3B, a larger electrode is used. In this example, the outer diameter of the anode is ½ inch. In general, according to embodiments of the present invention, the electrode has an outer diameter greater than 50% of the inner diameter of the reaction chamber cylinder. When used in conjunction with an annular sleeve 200 as described above, the electrode has an outer diameter greater than 50% of the bore diameter of the annular sleeve 200. In another embodiment, the outer diameter of the electrode is greater than 75% of the bore diameter. In yet another embodiment, the outer diameter of the electrode is greater than 90% of the bore diameter. In all embodiments, of course, the outer diameter of the electrode is less than 100 of the bore diameter.

A connection pin, such as a 1/16-inch connection pin, is connected to the electrode. This facilitates insertion and removal of the electrode into and out of the exothermic reaction chamber, as well as providing an electrical connection for attachment of a power supply. The connection pin may be machined into the rod, but can also be brazed into a hole drilled into the end of the electrode, or otherwise mechanically attached. The electrode is formed form a rugged metal, such as tungsten or molybdenum.

In another embodiment of the present invention, perturbations are formed on the outer surface of the electrode. These perturbations form sites for the generation of sparks, or electrical discharge from the anode to the cathode. The perturbations may be formed in a variety of ways.

In one embodiment, a wire is wound around the electrode in a spiral or helical pattern. The raised wire creates an irregular surface that may help the formation of arcing.

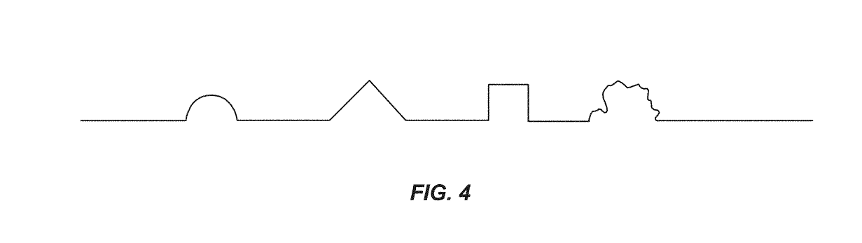

In another embodiment, the electrode is machined to generate a plurality of small raised protrusions. These may be smooth “bumps,” sharp “points,” polygonal protrusions, or other shapes (or combinations thereof). FIG. 4 depicts a section view of the surface of an electrode, with several representative protrusions machined thereon. The protrusions may, for example, be from 10 to 50 thousandths of an inch high. The protrusions may be formed in a regular, repeating pattern, or may be random. In general, the same pattern should be spread evenly around the periphery of the electrode, to induce an approximately even amount of electrical discharge in all radial directions.

FIG. 3C depicts another embodiment of an electrode 104 for an exothermic reaction chamber. The electrode 104 comprises an electrode body 122, which may for example comprise a machined rod, e.g., nickel or aluminum, having a diameter greater than that typical of the prior art (e.g., FIG. 3A), for example ½ inch. The electrode body 122 is supported by a support rod 120, which may for example comprise a molybdenum rode of 3/32 inch diameter. A plurality of holes, e.g., 1/16 inches each, are drilled through the electrode body 122, at 90° to the longitudinal axis, in this example. A 1/16-inch diameter metal dowel 124 is inserted into each hole, and cut such that a small portion of each end of the dowel protrudes from the outer surface of the electrode body 122. In one embodiment, the length of the dowels may be varied, for example to extend to at least 50%, or at least 75%, or at least 90% of the inner diameter of the exothermic reaction chamber cylinder or annular sleeve bore. Each set of holes may be drilled at a predetermined spacing interval, such as every ½ or 1 inch along the length of the electrode body 122. The tip of each dowel 124 may be filed or machined to a point, a rounded form, or any other shape, to provide a nucleation site for electrical discharge from the electrode 104 to the cathode of the reaction chamber 100.

FIG. 3D depicts another embodiment of the electrode 104, in which holes 126 are drilled through the electrode body 122 at an angle α to the longitudinal axis. In general, α may be any angle greater than 0° (along the axis), and up to 90° (perpendicular to the axis, as depicted in FIG. 3C). As discussed above, the holes 124 may be spaced along the electrode body 122, and drilled evenly around its periphery.

Exothermic reaction chamber electrodes according to embodiments of the present invention present numerous advantages over electrodes of the prior art. The current density between the electrodes is believed to be key to hydrogen loading of hydrogen-absorbing metals in exothermic reactions. The current depends primarily on the pressure inside the chamber and the distance between the anode and cathode. By reducing the distance from the outer surface of the anode electrode to the cathode surface, current density may be increased. Additionally, electrochemical reactions generally achieve better results in a harsh, active, high voltage environment. By forming perturbations at the surface of the anode electrode, more sparks may be expected, as the perturbations act as nucleation sites for the generation of electrical discharge events. Increased sparking increases the current density, driving more hydrogen and deuterium ions into the hydrogen-absorbing metal lattice structure.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. An exothermic reaction chamber, comprising:
a cylindrical metal housing having an inner diameter and at least one open end;
an annular sleeve having a longitudinal bore, the outer diameter of the sleeve being substantially equal to the metal housing inner diameter, the sleeve operative to be removeably disposed within the metal housing, the sleeve comprising a hydrogen-absorbing metal on at least a bore surface; and
a generally cylindrical electrode having an outer diameter less than the diameter of the bore, an outer surface of the electrode having a plurality of perturbations thereon operative to stimulate electrical discharge between the electrode and an inner surface of the annular sleeve.

2. The exothermic reaction chamber of claim 1, wherein the hydrogen-absorbing metal is plated onto the bore surface.

3. The exothermic reaction chamber of claim 2, wherein the hydrogen-absorbing metal is selected from the group comprising palladium and nickel.

4. The exothermic reaction chamber of claim 2, wherein a shielding metal is first plated onto the bore surface, and the hydrogen-absorbing metal is then plated onto the shielding metal.

5. The exothermic reaction chamber of claim 4, wherein the shielding metal is gold.

6. The exothermic reaction chamber of claim 1, wherein the outer surface of the annular sleeve and the inner surface of the cylindrical metal housing form a friction fit placing the annular sleeve and metal housing in a thermal transfer relationship.

7. The exothermic reaction chamber of claim 1, wherein the perturbations on the outer surface of the electrode form a helical spiral.

8. The exothermic reaction chamber of claim 7, wherein the helical spiral is formed by wrapping wire around the electrode in a helical pattern.

9. The exothermic reaction chamber of claim 1, wherein the perturbations on the outer surface of the electrode are machined.

10. The exothermic reaction chamber of claim 1, wherein
a plurality of holes are drilled through the housing, each at an angle to the longitudinal axis of the housing of between 0 and 90 degrees; and
a corresponding plurality of rods are inserted into the drilled holes, at least one end of each rod protruding slightly from the outer surface of the electrode to form the perturbations.

11. The exothermic reaction chamber of claim 10, wherein the ends of the rods are pointed.

12. The exothermic reaction chamber of claim 10, wherein the ends of the rods are rounded.

13. The exothermic reaction chamber of claim 1, wherein the outer diameter of the electrode is greater than 50% of the diameter of the bore of the annular sleeve.

14. The exothermic reaction chamber of claim 13, wherein the outer diameter of the electrode is greater than 75% of the diameter of the bore of the annular sleeve.

15. The exothermic reaction chamber of claim 14, wherein the outer diameter of the electrode is greater than 90% of the diameter of the bore of the annular sleeve.

16. The exothermic reaction chamber of claim 10, wherein
a plurality of holes are drilled through the rod, each at an angle to the longitudinal axis of the rod of between 0 and 90 degrees; and
a corresponding plurality of rods are inserted into the drilled holes, at least one end of each rod protruding slightly from the outer surface of the electrode to form the perturbations.

17. The exothermic reaction chamber of claim 16, wherein the ends of the rods are pointed.

18. The exothermic reaction chamber of claim 16, wherein the ends of the rods are rounded.

19. An annular sleeve for an exothermic reaction chamber comprising a cylindrical metal housing having an inner diameter and at least one open end, the annular sleeve comprising:
an annular sleeve formed of metal and having a longitudinal bore;
wherein the outer diameter of the annular sleeve is substantially equal to an inner diameter of the metal housing;
wherein the annular sleeve operative to be removeably disposed within the metal housing; and
wherein the annular sleeve comprises a hydrogen-absorbing metal on at least the bore surface.

20. The annular sleeve of claim 19, wherein the hydrogen-absorbing metal is plated onto the bore surface.

21. The annular sleeve of claim 20, wherein the hydrogen-absorbing metal is selected from the group consisting of palladium and nickel.

22. The annular sleeve of claim 20, wherein a shielding metal is first plated onto the bore surface, and the hydrogen-absorbing metal is then plated onto the shielding metal.

23. The annular sleeve of claim 22, wherein the shielding metal is gold.

24. The annular sleeve of claim 20, wherein an outer surface of the annular sleeve and the inner surface of the cylindrical metal housing form a friction fit placing the annular sleeve and metal housing in a thermal transfer relationship.

25. An electrode for an exothermic reaction chamber comprising a cylindrical metal housing having at least one open end and having a hydrogen-absorbing metal on the surface of an interior bore having a diameter, the electrode comprising:
generally cylindrical metal electrode having an outer diameter between 50% and 100% of the bore diameter, and further having a connection pin operative to connect the electrode to a power supply.
